(19) United States
(12) Patent Application Publication
(10) Pub. No.: US 2010/0137088 A1
(43) Pub. Date: Jun. 3, 2010

(54) TRANSMISSION CHAIN

(75) Inventors: Seigo Ohsawa, Osaka (JP); Arimasa Kaga, Osaka (JP)

Correspondence Address: Workman Nydegger;1000 Eagle Gate Tower, 60 East South Temple, Salt Lake City, UT, 84111, US

(73) Assignee: TSUBAKIMOTO CHAIN CO., Osaka (JP)

(21) Appl. No.: 12/618,519

(22) Filed: Nov. 13, 2009

(30) Foreign Application Priority Data
Dec. 3, 2008 (JP) 2008-308760

(51) Int. Cl. F16G 13/06; B21L 9/06

(52) U.S. Cl. 474/206; 59/7

(57) ABSTRACT

The invention provides a transmission chain including inner plates, bushings, outer plates, and a cylindrical hollow pin capable of supplying lubricant oil on a outer circumference of the pin across the whole area of the longitudinal direction of the pin when a chain is in operation, even when the chain is tensioned.

### CROSS REFERENCE TO RELATED APPLICATIONS

This application claims the foreign priority benefit under Title 35, United States Code, §119 (a)-(d) of Japanese Patent Application No. 2008-308760, filed on Dec. 3, 2008 in the Japan Patent Office, the disclosure of which is herein incorporated by reference in its entirety.

### BACKGROUND OF THE INVENTION

1. Field of the Invention

The present invention relates to a transmission chain. More specifically, the present invention relates to a transmission chain in an oil atmosphere for use in a transmission device of a power transmission mechanism of an industrial machine or the like.

2. Related Art

Power transmission mechanisms currently used in vehicles, industrial machines, and the like are typically provided with a transmission device which conveys power using a transmission chain suspended around driving and driven sprockets.

For instance, one instance where a transmission is used is in the engine of a vehicle provided with a timing drive system. The timing drive system conveys power using a transmission chain suspended around a crank sprocket, which is a driving sprocket, and a cam sprocket, which is a driven sprocket.

One transmission chain currently known in the art includes a roller chain and a bushing chain in which a plurality of link plates are formed. Each link plate has a pair of pin holes and the link plates are flexibly connected by means of connector pins inserted through the pair of pin holes in order to stagger the adjacent link plates in the longitudinal direction of the chain. More specifically, in a roller chain 500 currently known in the art which is shown in FIG. 11, a pair of bushings 530 are press fitted into both ends of the inner link plates in the lateral direction. Then a pair of outer link plates are added to the inner link plates of the roller chain using a pair of connector pins 560 which penetrate in the longitudinal direction through the bushings 530. The inner and outer links are assembled as described above in an alternate connection patter in the longitudinal direction of the chain, for example, as shown in Japanese Patent Application No. 2003-176853.

In another known configuration described in the transmission chain of Japanese Patent Application No. 2007-57377, a cylindrically-formed hollow pin is used as the connector pin.

One problem with these roller chains, however, is that the conventional roller chain 500 described above is that the gap or sliding area S formed between the outer circumference of the connector pin 560 and the inner circumference of the bushing 530 is reduced as shown in FIG. 11, when a tensile force is applied to the roller chain 500. This displaces the oil film formed in this sliding area S, and increases the likelihood of seizing and wear on the outer circumference of the pin and the inner circumference surface of the bushing.

### BRIEF DESCRIPTION OF THE INVENTION

Accordingly, in order to solve the aforementioned conventional problem, the present invention provides a transmission chain which is capable of supplying lubricant oil to the entire outer circumference of the pin during operation of the chain and of supplying the lubricant oil directly to the sliding area between the bushing and cylindrical hollow pin when a tension force is applied to the chain. The invention aims also at providing a transmission chain capable of preventing the surface pressure between the outer circumference of the pin and the inner circumference of the bushing from increasing when tension is applied to the chain.

A first aspect of the invention is a transmission chain comprising inner links each composed of a right and left inner plate having a pair of bushing holes formed therein with a front and a rear bushing press-fitted into the bushing holes so as to each be disposed between the right and left inner plate, and outer links each composed of a right and a left outer plate having a pair of pin holes formed therein with a front and a rear cylindrical hollow pin, wherein each of the front and rear cylindrical hollow pin is fitted through a pin hole of either the left or right outer plate, the bushings disposed between the right and left inner plate, and the remaining outer plate of the left or right outer plate, wherein the inner and outer links are alternately linked in the longitudinal direction of the chain and wherein lubricant oil disposed within the cylindrical hollow pin is supplied to the outer circumference of the pin through an oil communicating hole formed through a peripheral wall of the cylindrical hollow pin.

A second aspect of the invention is a method of manufacturing the transmission chain of the first aspect of the invention.

Then, according to the invention, in addition to providing smooth sliding action between the cylindrical hollow pin and the bushing by supplying the lubricant oil within the cylindrical hollow pin to the outer circumference of the pin, the invention provides advantages over the known art. For example, according to the transmission chain of the first aspect of the invention, the oil communicating hole is formed through the peripheral wall of the cylindrical hollow pin and the lubricant oil circulates from the inner circumference to the outer circumference of the cylindrical hollow pin through the oil communicating hole. This ensures that an oil film may be adequately be formed on the outer circumference of the pin in the area where the pressure is the greatest even when the lubricant oil is not fully supplied to the outer circumference of the pin. When the transmission chain of the invention is used within an oil atmosphere in particular, the lubricant oil which flows into the cylindrical hollow pin from the openings of the both ends of the cylindrical hollow pin is supplied to the outer circumference of the cylindrical hollow pin, so that the lubricant oil may be supplied to the part between the outer circumference of the pin and the inner circumference of the bushing during operation of the chain without requiring a special oil supplying means such as an oil tank and without requiring that the oil be supplied from outside the chain. Accordingly, it becomes possible to steadily suppress seizing and wear damage of the part between the outer circumference of the pin and the inner circumference of the bushing.

### BRIEF DESCRIPTION OF THE DRAWINGS

FIG. 1 is cross-sectional view of a transmission chain according to a first embodiment of the invention;

FIG. 2 is a section view of the transmission chain shown in FIG. 1;

FIG. 3 is a perspective view showing a cylindrical hollow pin used for the transmission chain shown in FIG. 1 according to one embodiment of the invention;

FIG. 4 is a cross-sectional view showing a sliding state of the cylindrical hollow pin with a bushing;

FIG. 5 is an explanatory view showing an exaggerated deformation of parts in the vicinity of both ends of the bushing;

FIG. 6 is a perspective view showing a plate member to be used to form the cylindrical hollow pin;

FIG. 7 is a perspective view showing a first modified example of the cylindrical hollow pin according to a second embodiment of the invention;

FIG. 8 is a perspective view showing a second modified example of the cylindrical hollow pin according to a third embodiment of the invention;

FIG. 9 is a perspective view showing a third modified example of the cylindrical hollow pin according to a fourth embodiment of the invention;

FIG. 10 is a perspective view showing a plate member to be used for the cylindrical hollow pin shown in FIG. 9; and

FIG. 11 is a cross-sectional view showing a sliding state of a connector pin with a bushing in a conventional roller chain currently known in the art.

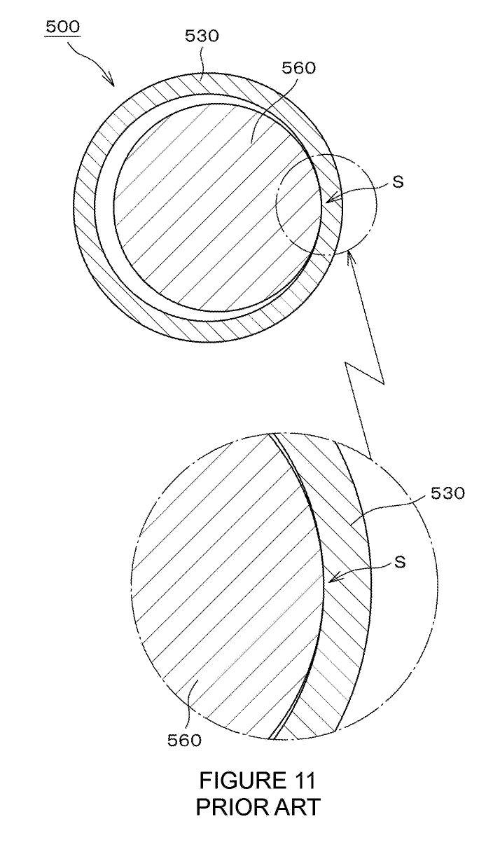

### DETAILED DESCRIPTION OF THE PREFERRED EMBODIMENTS

In the transmission chain described below, embodiments may be modified without departing from the scope of the following claims. For example, the transmission chain of the invention may be either a roller chain or a bushing chain. Furthermore, the specific mode of forming the oil communicating hole formed through the cylindrical hollow pin may vary. For example, the hole may be circular and provided one at the center of the longitudinal direction of the pin, or the hole may be semi-circular, with a number of holes being provided in the longitudinal direction of the pin. Thus, any variety of configurations may be used in order to circulate the lubricant oil from the inner circumference to the outer circumference of the cylindrical hollow pin.

It is also noted that the specific configuration of the oil guiding groove formed on the cylindrical hollow pin may also vary. For example, the oil guiding groove may comprise a linear belt extending along the longitudinal direction of the pin, a curved belt, formed like a wavy line extending along the longitudinal direction of the pin, or the like as long as it guides the lubricant oil circulated from the oil communicating hole to the outer circumference of the pin in the longitudinal direction thereof.

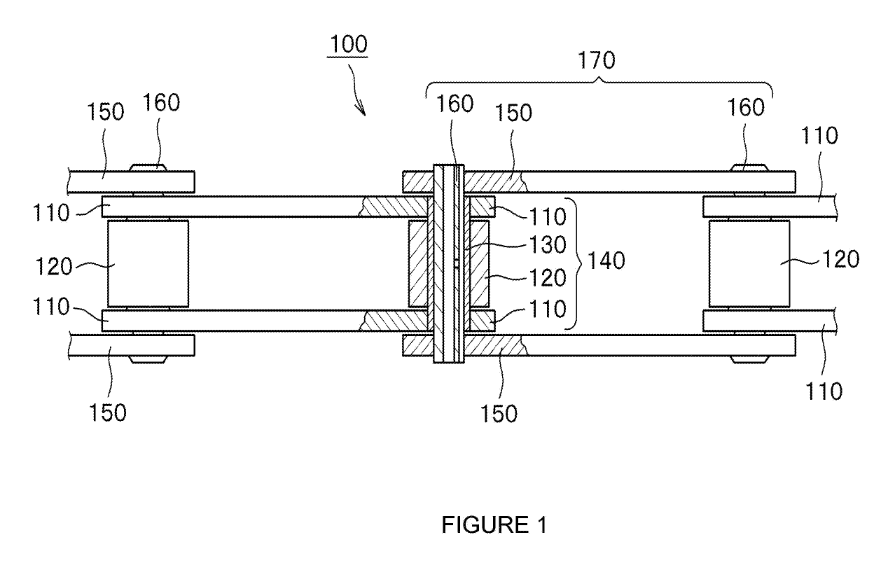

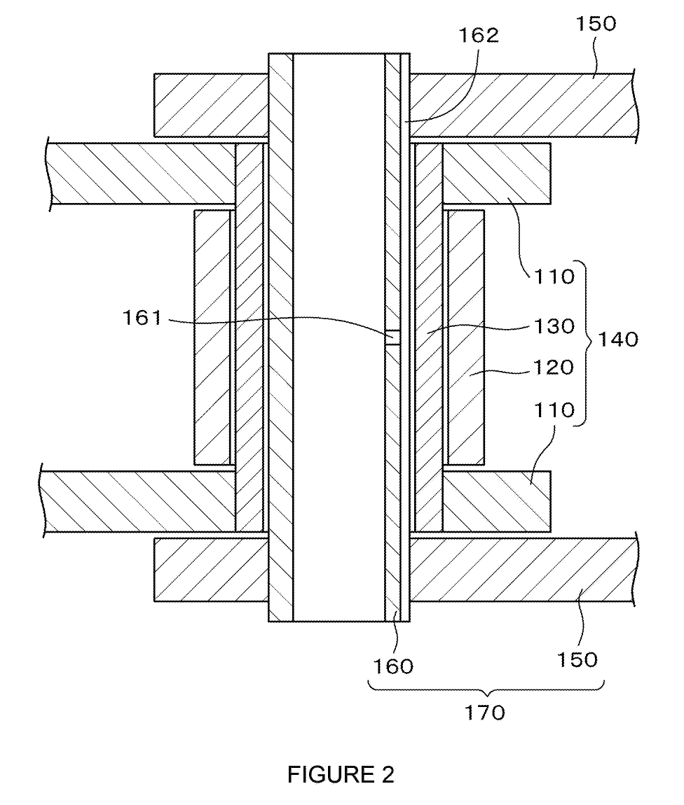

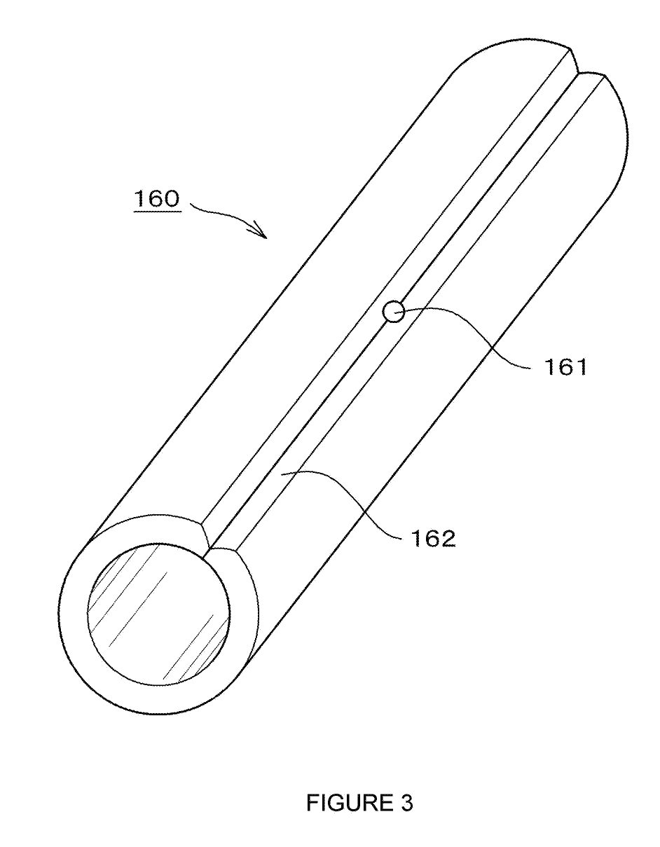

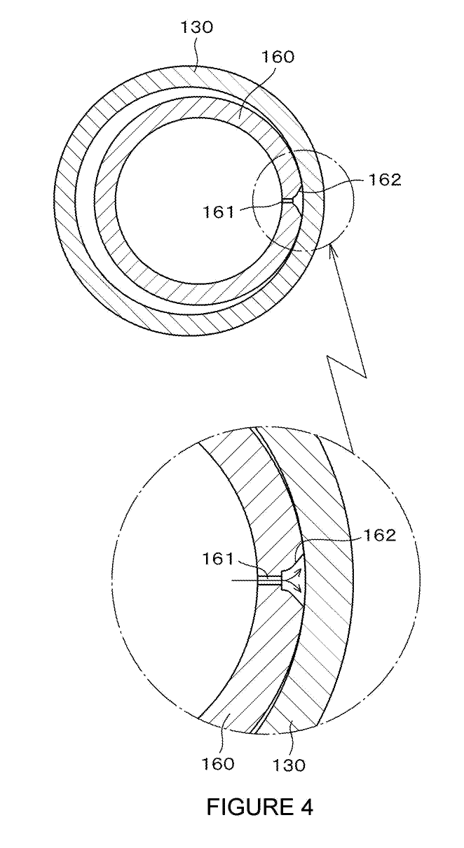

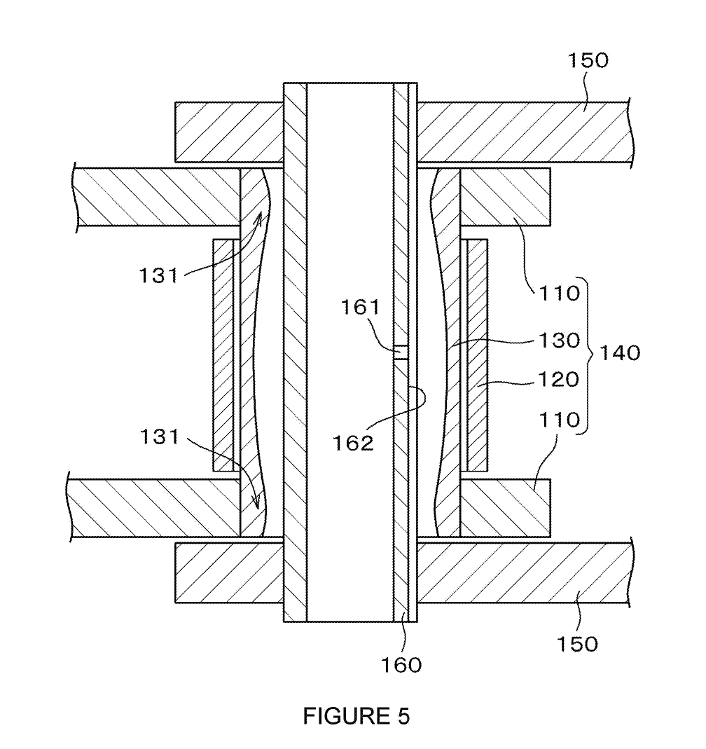

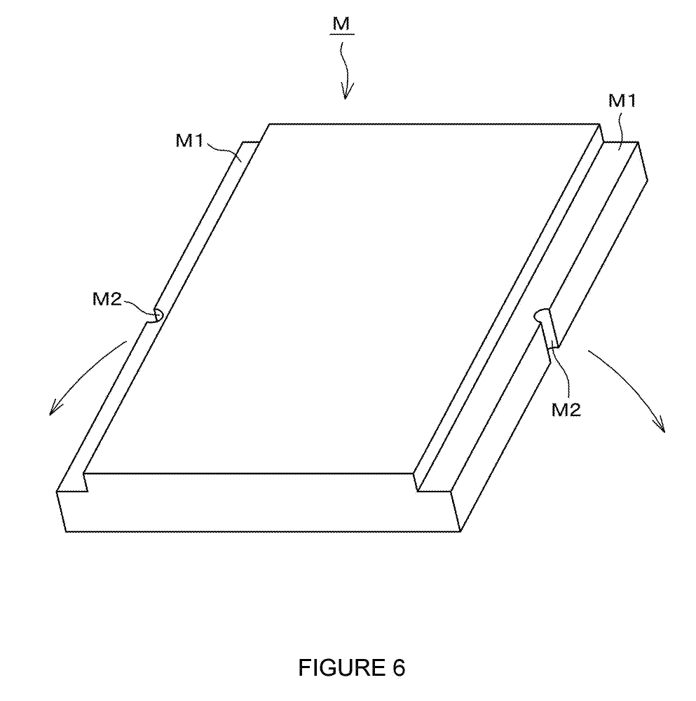

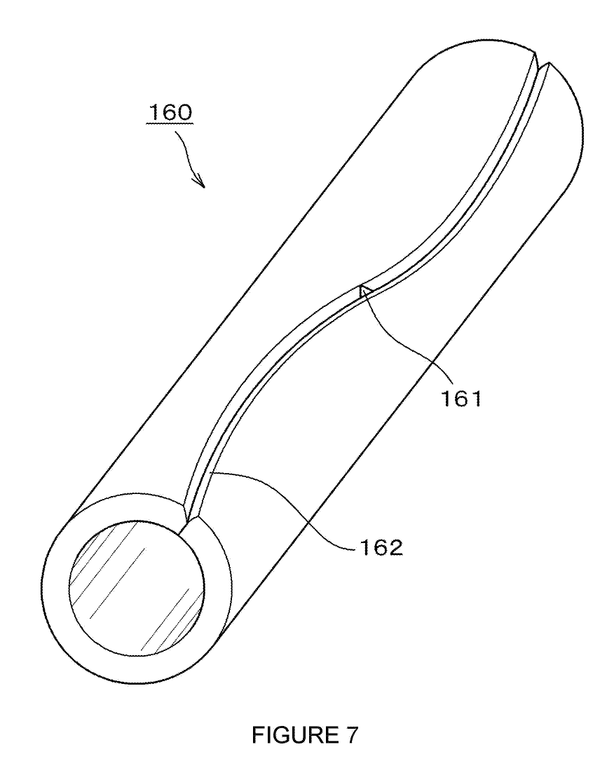

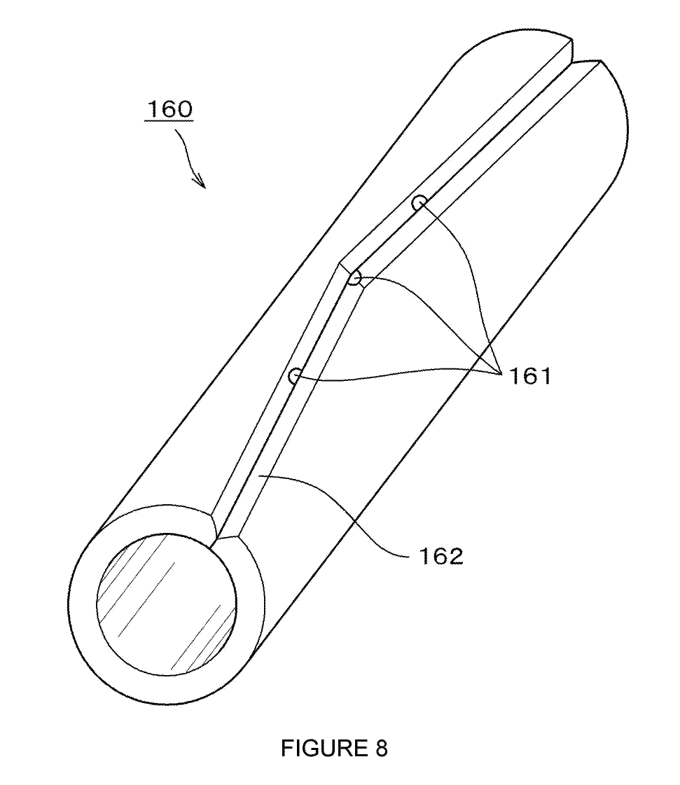

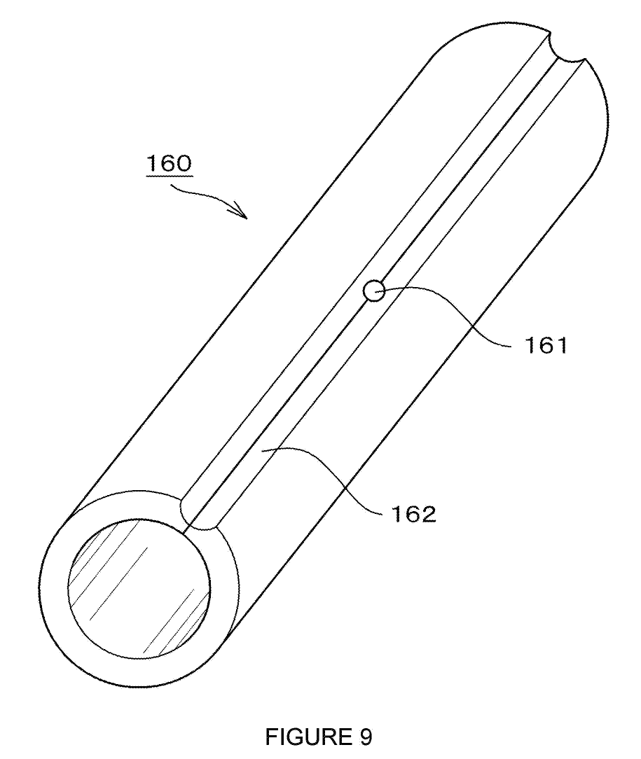

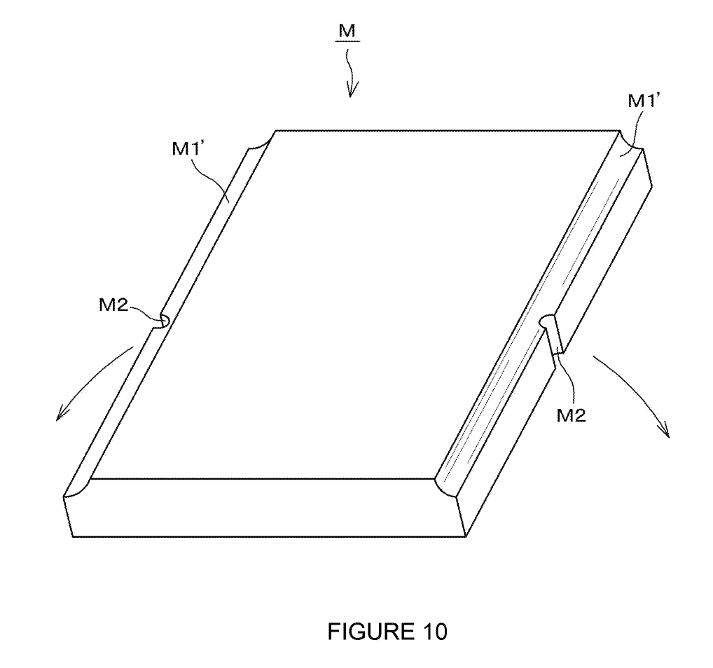

The transmission chain 100 according to a first embodiment of the invention will be explained with reference to the drawings. FIG. 1 is a cross-section of the transmission chain. FIG. 2 is a sectional view of the transmission chain shown in FIG. 1, and FIG. 3 is a perspective view showing a cylindrical hollow pin used for the transmission chain shown in FIG. 1 according to a first embodiment of the invention. FIG. 4 is a section view showing a sliding state of the cylindrical hollow pin with a bushing, FIG. 5 is an explanatory view showing an exaggerated deformation of parts in the vicinity of both ends of the bushing and FIG. 6 is a perspective view showing a plate member to be used for the cylindrical hollow pin. FIG. 7 is a perspective view showing a first modified example of the cylindrical hollow pin according to a second embodiment of the invention, FIG. 8 is a perspective view showing a second modified example of the cylindrical hollow pin according to a third embodiment of the invention and FIG. 9 is a perspective view showing a third modified example of the cylindrical hollow pin according to a fourth embodiment of the invention. FIG. 10 is a perspective view showing a plate member to be used for the cylindrical hollow pin shown in FIG. 9.

The transmission chain 100 of the first embodiment of the invention is a timing chain for use in a timing system within an automobile engine. As shown in FIGS. 1 and 2, the transmission chain 100 has an inner link 140 including a pair of inner plates 110 which are separated by a pair of front and rear bushings 130 press-fitted into bushing holes of the inner plates 110. A roller 120 is fitted between the of inner plates 110 around the bushings 130. An outer link 170 is attached to the inner link 140 by fitting a pair of front and rear cylindrical hollow pins 160 into pin holes of a pair of outer plates 150 disposed on either side of the inner link 140 and through the front and rear bushings 130 of the inner link 140.

The specific configuration of the cylindrical hollow pin 160 featured most in the transmission chain 100 of the present embodiment will be explained in detail with reference to FIGS. 2 through 8. As shown in FIGS. 2-4, the cylindrical hollow pin 160 is provided with the oil communicating hole 161 formed through the peripheral wall of the cylindrical hollow pin 160. The oil communicating hole 161 circulates oil within the engine which flows into the inner circumference of the pin from the openings of the both ends of the cylindrical hollow pin 160 to the side of the outer circumference of the pin.

As shown in FIGS. 2-4, an oil guiding groove 162 guides the lubricant oil circulated from the oil communicating hole 161 described above. The oil guiding groove 162 is formed so as to be concave on the outer circumference of the cylindrical hollow pin 160 in the longitudinal direction of the pin while communicating with the oil communicating hole 161.

The oil communicating hole 161 and the oil guiding groove 162 are formed in the sliding area S between the outer circumference of the cylindrical hollow pin 160 and the inner circumference of the bushing 130 where the greatest pressure is applied when the chain is tensioned, as shown in FIG. 4. As such, the lubricant oil is supplied directly to the sliding area S between the outer circumference of the pin and the inner circumference of the bushing when the gap of the sliding area S is reduced where the oil film is typically displaced when the chain is tensioned.

The oil communicating hole 161 is located in the middle of the inner link 140. That is, the oil communicating hole 161 is formed at the longitudinal center of the cylindrical hollow pin 160 so as to avoid parts 131 near the both ends of the bushing 130, which are prone to be deformed when the bushing 130 is press-fitted into the bushing hole of the inner plate 110, from sliding with the oil communicating hole 161 as shown in FIG. 5. It is noted that FIG. 5 shows an exaggerated deformation of the parts 131 near the both ends of the bushing 130.

As shown in FIG. 6, the cylindrical hollow pin 160 is formed by bending a plate member M having step portion M1 formed in each end and semi-cylindrical cutout portions M2 formed in the longitudinal center of the step portions M1 into a cylinder. As a result of bending of the plate member M, the step portions M1 align, thus forming the oil guiding groove 162. Similarly, the cutout portions M2 described above align, so as to form the oil communicating hole 161.

The lubricant oil circulated into the inner circumference of the cylindrical hollow pin 160 is supplied to the outer circumference of the pin through a capillary phenomenon caused by very small holes unavoidably being formed at the joint line of the plate member M formed by bending the plate member M into the cylindrical hollow pin 160.

Additionally, it is possible to avoid requiring a difficult molding process that would likely result in a distorted cylindrical hollow pin 160 if the oil communicating hole 161 and the oil guiding groove 162 were formed after bending the plate member M. Thus, forming the step portions M1 and cutout portions M2 in the plate member M before bending the plate member M into the cylindrical hollow pin 160 increases manufacturing efficiency.

It is noted that the oil communicating hole 161 may have any configuration as long as it circulates the lubricant oil from the inner circumference of the cylindrical hollow pin 160 to the outer circumference of the pin. Although one circular oil communicating hole 161 is formed at the center of the longitudinal direction of the pin as shown in FIGS. 2-4, one triangularly-shaped wedge may be provided at the center of the longitudinal direction of the pin as shown in FIG. 7. Furthermore, three different semi-circular holes may be provided in the longitudinal direction of the pin as shown in FIG. 8.

Similarly, the oil guiding groove 162 may have any configuration so long as the oil guiding groove 162 guides the lubricant oil from the oil communicating hole 161 along the outer circumference of the pin in the longitudinal direction. For example, although the oil guiding groove 162 is described above as a straight line which extends in the longitudinal direction of the pin, it may curved like a wavy line that extends along the longitudinal direction of the pin as shown in FIG. 7, or may be formed like a line that bends at the longitudinal center of the pin.

Furthermore, the specific shape of the oil guiding groove 162 is not limited to be a groove with a V-shaped cross-section as shown in FIG. 3. It may have a variety of shapes, such as the U-shaped cross-section shown in FIG. 9. In this case, the oil guiding groove 162 with a U-shaped cross-section may be formed by cylindrically bending the plate member M shown in FIG. 10, which has C-curved cutout portions M1′.

The transmission chain 100 of the present embodiment thus has an communicating hole 161 formed through the peripheral wall of the cylindrical hollow pin 160. Accordingly, the lubricant oil within the engine circulated from the opening of the both ends of the cylindrical hollow pin 160 into the cylindrical hollow pin 160 is supplied to the outer circumference of the cylindrical hollow pin 160 through the oil communicating hole 161, so that the lubricant oil may be supplied between the outer circumference of the pin and the inner circumference of the bushing during operation of the chain without providing a specific oil supplying means such as an oil supply tank or requiring an oil supply from outside the chain. Thus, it is possible to reliably suppress seizing and wear damage of the part between the outer circumference of the pin and the inner circumference of the bushing.

Furthermore, the oil guiding groove 162 that communicates with the oil communicating hole 161 is concaved across the longitudinal direction of the pin on the outer circumference of the cylindrical hollow pin. Accordingly, the lubricant oil circulated to the outer circumference of the pin from the oil communicating hole 161 is guided to the whole area of longitudinal direction of the pin through the oil guiding groove 162, so that it is possible to form an oil film on the outer circumference of the pin across the entire of the longitudinal direction of the pin.

Additionally, the oil guiding groove 162 is provided in the sliding area S between the bushing 130 and the cylindrical hollow pin 160 formed when the transmission chain 100 is tensioned. Accordingly, the lubricant oil is supplied directly to the sliding area S between the bushing 130 and the cylindrical hollow pin 160 where the gap is reduced and the oil film is typically displaced when the chain is tensioned, so that it becomes possible to steadily prevent sizing and wear damage of the part between the bushing 130 and the cylindrical hollow pin 160 by efficiently supplying the lubricant oil.

The oil communicating hole 161 is located in the middle of the inner link 140. Accordingly, it is possible to avoid the parts 131 near the both ends of the bushing 130 which are prone to deformation when the bushing 130 is press-fitted into the bushing hole of the inner plate 110 from sliding with the oil communicating hole 161, so that it is also possible to prevent the surface pressure between the outer circumference of the pin and the inner circumference of the bushing from locally increasing.

Finally, the oil communicating hole 161 and the oil guiding groove 162 may be easily formed in a plate member M formed which is subsequently bent so as to form the cylindrical hollow pin 160. Accordingly, in addition to the lubricant oil that circulates to the outer circumference of the pin through the oil communicating hole 161, the lubricant oil circulated to the outer circumference of the pin from the inner circumference of the pin through the capillary phenomenon caused by the very small holes unavoidably formed at the joint line part of the plate member M extrudes and is supplied to the oil guiding groove 162, so that the oil film may be formed on the outer circumference of the pin for a long period time, thus causing the remarkable effects.

1. A transmission chain including a plurality of segments, wherein each segment of the transmission chain comprises:
at least one inner link, where each inner link includes a right inner plate and a left inner plate, each including a pair of bushing holes, with a pair of front and rear bushings disposed between the right and left inner plate which are press-fitted into the bushing holes of the right and left inner plate;
at least one outer link, where each outer link includes a pair of front and rear cylindrical hollow pins inserted through the front and rear bushings of the inner link, respectively, and a pin hole of each of a pair outer plates; and
lubricant oil disposed within the front and rear cylindrical hollow pins which is supplied to the outer circumference of the front and rear cylindrical hollow pins,
wherein the oil communicating hole for circulating the lubricant oil from the inner circumference to the outer circumference of the front and rear cylindrical pin is formed through a peripheral wall of each of the front and rear cylindrical hollow pins.

2. The transmission chain according to claim 1, wherein the front and rear cylindrical hollow pins further comprise an oil guiding groove that communicates with the oil communicating hole to guide the lubricant oil to the both ends of the cylindrical hollow pin, the oil guiding groove being a concave portion formed on the outer circumference of the cylindrical hollow pin along the length of the pin.

3. The transmission chain according to claim 1, wherein the oil communicating hole is provided in an area where the cylindrical hollow pin slides with respect to the bushing when the chain is tensioned.

4. The transmission chain according to claim 1, wherein the oil communicating hole is disposed so as to be located in the middle of the inner link.

5. The transmission chain according to claim 2, wherein the oil communicating hole and the oil guiding groove are provided at joint line parts of a plate member which is cylindrically bent so as to form the front or rear cylindrical hollow pin.

6. The transmission chain according to claim 1, wherein the oil communicating hole is provided at joint line parts of a plate member which is cylindrically bent so as to form the front or rear cylindrical hollow pin.

7. The transmission chain according to claim 1, wherein more than one oil communicating hole is formed through the peripheral wall of each of the front and rear cylindrical hollow pins.

8. A method for forming a transmission chain including at least one inner link and at least one outer link, where each inner link includes a pair of inner plates, each including a pair of bushing holes into which a pair of bushings are press-fitted, so that the inner plates are disposed on opposite sides of the pair of bushings, and where the outer link includes a pair outer plates, each including a pair of pin holes, the method comprising:
forming two plate members, each including a first hole portion formed on one edge and a second hole portion formed on the opposite edge;
rolling the two plate members so that the first hole portion and second hole portions align, so as to form two cylindrical hollow pins, each with an oil communicating hole formed therein;
inserting a cylindrical hollow pin through each of the pair of bushings of the inner link;
fitting the pair of outer plates on either side of the inner link by inserting the cylindrical hollow pins through the pair of pin holes of the pair of outer plates; and
supplying a lubricant oil through an end of the cylindrical hollow pins into the inside of the cylindrical hollow pins,
wherein the oil communicating hole of the cylindrical hollow pins supplies the lubricant oil from the inner circumference to the outer circumference of the cylindrical pins.

9. The method according to claim 8, further comprising forming an concave portion along the length of each edge of the two plate members so that an oil guiding groove is formed on the outer circumference of the cylindrical hollow pin along the length of the pin when the two plate members are rolled.

10. The method according to claim 9, wherein the oil guiding groove supplies the lubricant oil from the oil communicating hole along the outer circumference of the cylindrical pins.
